(19) United States
(12) Patent Application Publication
(10) Pub. No.: US 2025/0300353 A1
(43) Pub. Date: Sep. 25, 2025

(54) ANTENNA DEVICE FOR VEHICLE

(71) Applicants: Hyundai Motor Company, Seoul (KR); Kia Corporation, Seoul (KR); Winnercom Co., Ltd., Gyeongsangnam (KR)

(72) Inventors: Byoung Hyun Lee, Yongin (KR); Keun Ho Baek, Hanam (KR); Jae Hoon Jung, Suwon (KR)

(21) Appl. No.: 18/970,579

(22) Filed: Dec. 5, 2024

(30) Foreign Application Priority Data
Mar. 21, 2024 (KR) 10-2024-0039059

(51) Int. Cl. H01Q 9/04

(52) U.S. Cl. CPC H01Q 9/0428

(57) ABSTRACT

An antenna device for a vehicle includes: a patch antenna configured to implement circular polarization; a ground plane in contact with a lower surface of the patch antenna; and a reflector spaced apart from the patch antenna and arranged to surround at least one side surface of the patch antenna.

### CROSS-REFERENCE TO RELATED APPLICATION

This application claims under 35 U.S.C. § 119(a) the benefit of Korean Patent Application No. 10-2024-0039059, filed on Mar. 21, 2024, the entire contents of which are incorporated herein by reference.

### BACKGROUND

### (a) Technical Field

The present disclosure relates to a vehicle antenna device

### (b) Description of the Related Art

A conventional vehicle GNSS (Global Navigation Satellite System) patch antenna is built in a shark antenna and mounted on a roof of a vehicle. This structure is effective in receiving satellite signals because the main beam of the patch antenna radiates in a direction perpendicular to the ground plane, that is, toward the sky.

Recently, there is a trend to install antenna components inside the vehicle to implement a hidden antenna. Accordingly, as the antenna is miniaturized due to restrictions on the mounting location, a PCB (Printed Circuit Board) is also reduced, reducing the ground area, and the vehicle body, such as the vehicle roof, could not be used as a wide ground surface.

The GNSS patch antenna with insufficient grounding have a problem in that the main beam is pointed in a different direction, such as the floor, rather than toward the sky, which reduces the reception sensitivity of satellite signals. Therefore, it is necessary to improve the reception sensitivity of satellite signals by directing the main beam toward the sky while maintaining the circular polarization of the patch antenna.

### SUMMARY

According to at least one aspect, the present disclosure provides a vehicle antenna device includes: a patch antenna that implements circular polarization; a ground plane in contact with a lower surface of the patch antenna; and a reflector spaced apart from the patch antenna and arranged to surround side surfaces of the patch antenna.

In another aspect, an antenna device for a vehicle includes: a patch antenna configured to implement circular polarization; a ground plane in contact with a lower surface of the patch antenna; and a reflector spaced apart from the patch antenna and arranged to surround at least one side surface of the patch antenna.

The reflector may include at least one side wall configured to surround the at least one side surface of the patch antenna. The reflector may include a plurality of side walls. The reflector may include n number of side walls. A height of each of the plurality of side walls may be the same as a height of the patch antenna. Each of the plurality of side walls may be formed in a ‘T’ shape.

Each of the plurality of side walls may include: a first extension part extending from the ground plane along a height direction of the patch antenna; and a second extension part extending along a direction perpendicular to the height direction. The second extension part may be arranged parallel to an adjacent side surface of the patch antenna. The second extension part may be arranged parallel to a most adjacent side surface among the side surfaces of the patch antenna. A length of the second extension part may be greater than or equal to a horizontal length of the most adjacent side surface of the patch antenna. Each of the plurality of side walls may be disposed such that one end of the first extension part contacts the ground plane. A center in an extension direction of the second extension part may contact another end of the first extension part. When viewed in a direction from an upper surface of the patch antenna toward a lower surface, the patch antenna may be formed in an n-polygon, n being a natural number of 3 or more.

A vehicle may include the antenna device.

According to a further aspect, an antenna device for a vehicle may include: a patch antenna configured to implement circular polarization; a ground plane in contact with a lower surface of the patch antenna; and a reflector having a plurality of side walls each spaced apart from the patch antenna and arranged to surround side surfaces of the patch antenna.

ground plane

### BRIEF DESCRIPTION OF THE DRAWINGS

FIG. 1 is a perspective view of a vehicle antenna device according to one embodiment of the present disclosure.

FIGS. 2A and 2B are diagrams showing 3D radiation patterns of a patch antenna for cases without and with a reflector according to one embodiment of the present disclosure, respectively.

FIGS. 3A and 3B are diagrams showing 2D radiation patterns of a patch antenna for cases without and with the reflector according to one embodiment of the present disclosure, respectively.

FIGS. 4A to 4C are diagrams showing the vehicle antenna device for a case where the height of a side wall is the same as the height of the patch antenna, a case where the height of the side wall is lower than the height of the patch antenna, and a case where the height of the side wall is higher than the height of the patch antenna, respectively.

FIGS. 5A to 5C are diagrams showing 3D radiation patterns for the respective vehicle antenna devices of FIG. 4A to 4C.

FIGS. 6A and 6B are diagrams illustrating the vehicle antenna device for a case where the length of a second extension part is shorter than the horizontal length of the patch antenna and a case where the length of the second extension part is longer than the horizontal length of the patch antenna, respectively.

FIGS. 7A and 7B are diagrams showing 3D radiation patterns for the respective vehicle antenna devices of FIGS. 6A and 6B.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMS, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

In view of the above, the present disclosure provides a vehicle antenna device capable of directing the main beam toward the sky while maintaining the circular polarization of a patch antenna by using side walls arranged to surround the patch antenna.

According to one embodiment, the present disclosure provides a vehicle antenna device capable of easily tuning the antenna according to the conditions of a ground plane by adjusting a length of a first extension part and a second extension part of a side wall.

The objects to be achieved by the present disclosure are not limited to the objects mentioned above, and other objects not mentioned will be clearly understood by one of ordinary skill in the art from the description below.

Hereinafter, some exemplary embodiments of the present disclosure will be described in detail with reference to the accompanying drawings. In the following description, like reference numerals preferably designate like elements, although the elements are shown in different drawings. Further, in the following description of some embodiments, a detailed description of known functions and configurations incorporated therein will be omitted for the purpose of clarity and for brevity.

Additionally, various terms such as first, second, A, B, (a), (b), etc., are used solely to differentiate one component from the other but not to imply or suggest the substances, order, or sequence of the components.

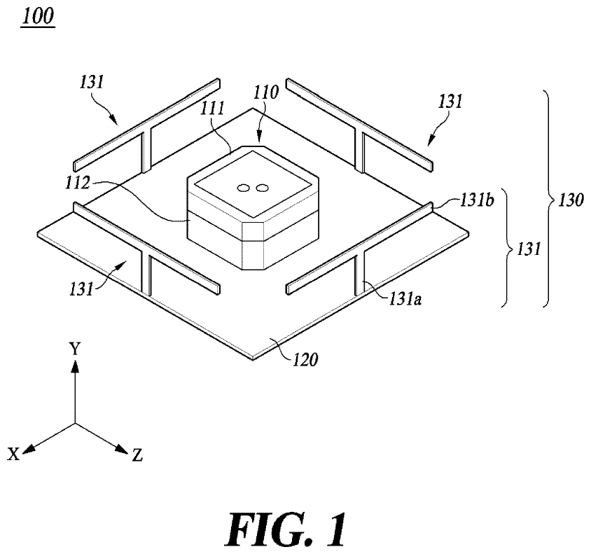

FIG. 1 is a perspective view of a vehicle antenna device according to one embodiment of the present disclosure.

Referring to FIG. 1, a vehicle antenna device 100 according to one embodiment of the present disclosure may include a patch antenna 110, a ground plane 120, and a reflector 130.

The reflector 130 may include a side wall 131.

The side wall 131 may include a first extension part 131a and a second extension part 131b.

The patch antenna 110 is configured to implement circular polarization, for example, right-handed circular polarization (RHCP). The patch antenna 110 is arranged so that its lower surface is in contact with the ground plane 120. The patch antenna 110 may be arranged to be surrounded by a reflector 130 disposed to be spaced apart from the patch antenna 110. The patch antenna 110 may be arranged to be surrounded by a plurality of side walls 131.

When viewed in a direction from an upper surface 111 of the patch antenna 110 toward the lower surface, the patch antenna 110 may be formed as an n-polygon (n being a natural number of 3 or more) (e.g., a square). In this case, as shown in FIG. 1, at least one of the corners of the n-polygon may be chamfered. In addition, the direction from the upper surface to the lower surface means the opposite direction to the Y-axis direction in FIG. 1.

The ground plane 120 is in contact with the lower surface of the patch antenna 110. A plurality of side walls 131 may be disposed on the ground plane 120. The ground plane 120 may contact one end of the first extension part 131a of each of the plurality of side walls 131. The ground plane 120 may be a printed circuit board (PCB) or a dielectric substrate such as ceramic.

The reflector 130 is spaced apart from the patch antenna 110 and is arranged to surround a side surface 112 of the patch antenna 110. The reflector 130 may be made of a conductor to reflect the beam from the patch antenna 110. The reflector 130 may include a plurality of side walls 131.

Each of the plurality of side walls 131 may include the first extension part 131a extending from the ground plane 120 along a height direction (Y-axis direction in FIG. 1) of the patch antenna 110, and the second extension part 131b extending along a direction perpendicular to the height direction (e.g., X-axis direction in FIG. 1) and disposed parallel to the side surface 112 of the patch antenna 110 most adjacent thereto among the side surfaces 112 of the patch antenna 110.

Each of the plurality of side walls 131 may be disposed such that one end of the first extension part 131a contacts the ground plane 120, and the center in the extension direction of the second extension part 131b contacts the other end of the first extension part 131a. For example, each of the plurality of side walls may be formed in the same or similar shape as a ‘T’. By configuring the side wall 131 surrounding the patch antenna 110 to include the first extension part 131a and the second extension part 131b, it is advantageous that the antenna can be freely tuned by adjusting a height (length of the first extension part 131a) and/or a width (length of the second extension part 131b) of the side wall 131 depending on the conditions of the ground plane 120.

As described above, when viewed in a direction from the upper surface 111 of the patch antenna 110 toward the lower surface, the patch antenna 110 may be formed as an n-polygon with at least one of the corners chamfered. In this case, the reflector 130 may be configured to surround all side surfaces 112 of the patch antenna 110, including n number of side walls 131. By arranging the plurality of side walls 131 to surround all side surfaces 112 of the patch antenna 110, the main beam is directed toward the sky while maintaining the circular polarization of the patch antenna 110 even in situations where the ground is insufficient, which improves reception sensitivity of satellite signals.

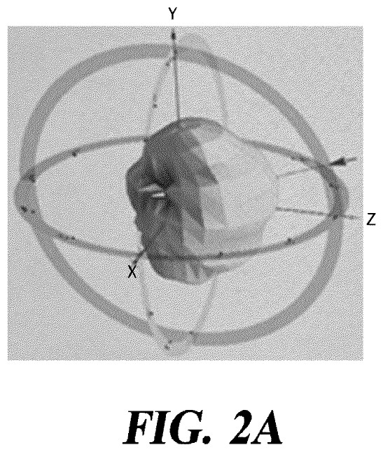

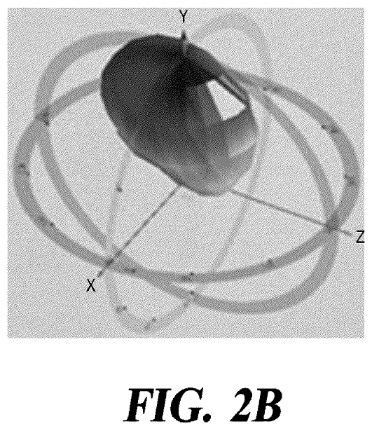

FIGS. 2A and 2B are diagrams showing 3D radiation patterns of the patch antenna for cases without and with the reflector according to one embodiment of the present disclosure, respectively.

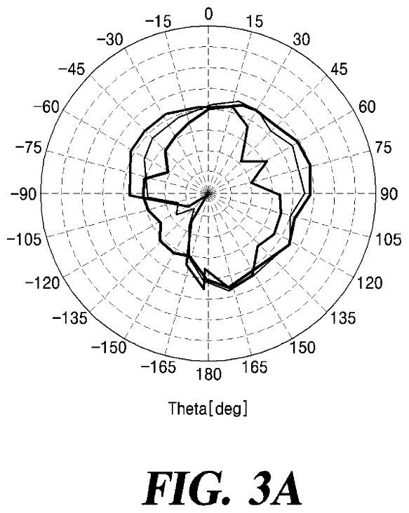

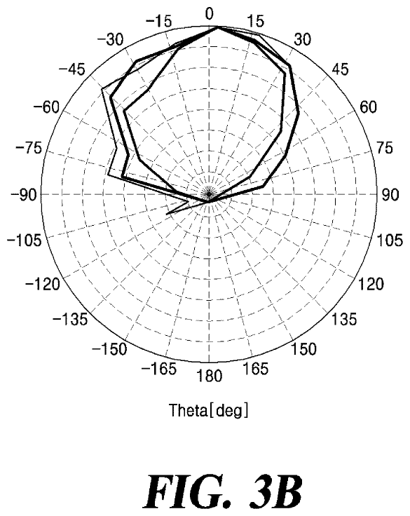

FIGS. 3A and 3B are diagrams showing 2D radiation patterns of the patch antenna for cases without and with the reflector according to one embodiment of the present disclosure, respectively.

Specifically, FIG. 2A and FIG. 3A show the case where the patch antenna 110 is not surrounded by the side wall 131, and FIG. 2B and FIG. 3B show the case where the patch antenna 110 is surrounded by the side wall 131.

Referring to FIGS. 2A to 3B, it can be seen that when the patch antenna 110 is not surrounded by the side wall 131, a back lobe phenomenon occurs in which the radiation pattern is formed in a direction opposite to the sky direction (Z-axis direction in FIGS. 2A and 2B and 0-degree direction in FIGS. 3A and 3B), whereas when the patch antenna 110 is surrounded by the side walls 131, the back lobe phenomenon hardly occurs and the beam is directed toward the sky. In this way, in the vehicle antenna device 100 according to the present disclosure including the side walls 131 surrounding the patch antenna 110, the main beam of the patch antenna 110 is directed toward the sky even in situations where the ground is insufficient, which results in improved reception sensitivity of satellite signals.

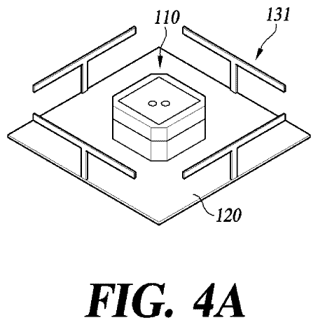

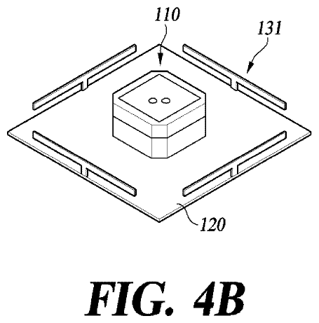

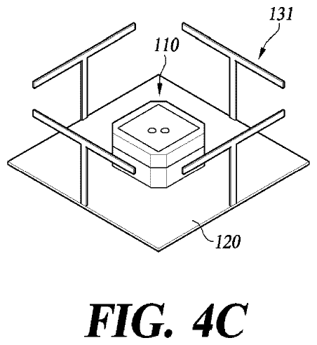

FIGS. 4A to 4C are diagram showing the vehicle antenna device for a case where the height of the side wall is the same as the height of the patch antenna, a case where the height of the side wall is lower than the height of the patch antenna, and a case where the height of the side wall is higher than the height of the patch antenna, respectively.

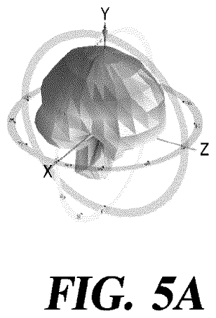

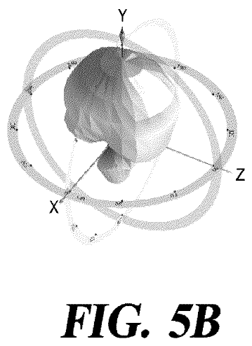

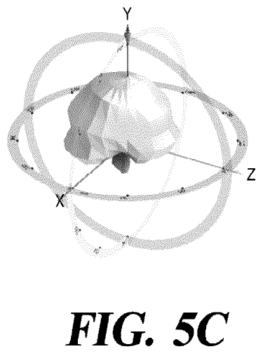

FIGS. 5A to 5C are diagram showing 3D radiation patterns for the respective vehicle antenna devices of FIG. 4A to 4C.

Specifically, FIG. 4A and FIG. 5A show the case where the height of the side wall 131 is the same as the height of the patch antenna 110, and FIG. 4B and FIG. 5B represents the case where the height of the side wall 131 is lower than the height of the patch antenna 110, and FIG. 4C and FIG. 5C show the case where the height of the side wall 131 is lower than the height of the patch antenna 110.

Referring to FIGS. 4A to 5C, it can be seen that the radiation pattern of the patch antenna 110 is more concentrated toward the sky in the case where the height of the side wall 131 is the same as the height of the patch antenna 110, compared to the case where the height of the side wall 131 is excessively lower or higher than the height of the patch antenna 110. Accordingly, the height of each of the plurality of side walls 131 according to the present disclosure may be the same or similar to the height of the patch antenna 110. In this case, similar heights may mean that the difference between the height of the side wall 131 and the height of the patch antenna 110 is less than or equal to a predetermined value (e.g., 10% of the height of the patch antenna 110). The vehicle antenna device 100 according to the present disclosure is configured such that the height of the plurality of side walls 131 surrounding the patch antenna 110 is the same or similar to the height of the patch antenna 110, thereby concentrating the radiation pattern of the patch antenna 110 toward the sky and effectively improving the reception sensitivity of satellite signals.

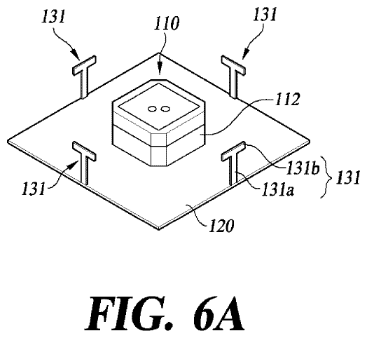

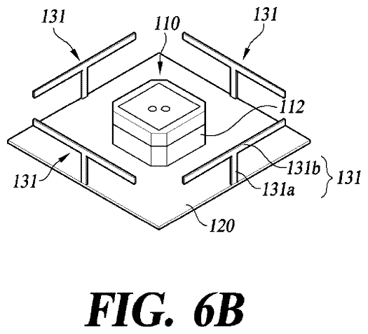

FIGS. 6A and 6B are diagram illustrating the vehicle antenna device for a case where the length of the second extension is shorter than the horizontal length of the patch antenna and a case where the length of the second extension is longer than the horizontal length of the patch antenna, respectively.

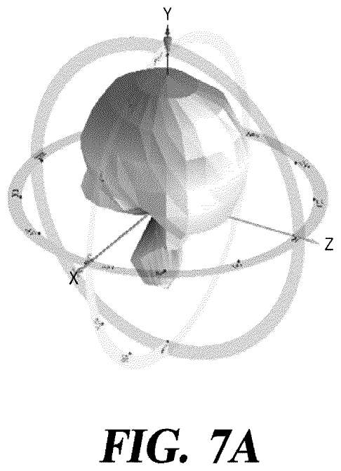

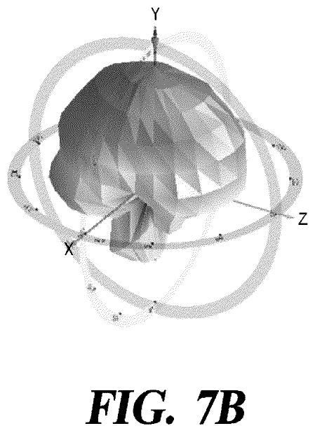

FIGS. 7A and 7B are diagrams showing 3D radiation patterns for the respective vehicle antenna devices of FIGS. 6A and 6B.

Specifically, FIG. 6A and FIG. 7A show the case where the length of the second extension part 131b of the side wall 131 is shorter than the length in the horizontal direction (X-axis or Z-axis in FIG. 1) of the most adjacent side surface 112 of the patch antenna 110, and FIG. 6B and FIG. 7B show the case where the length of the second extension part 131b of the side wall 131 is longer than the length in the horizontal direction of the most adjacent side surface 112 of the patch antenna 110.

Referring to FIGS. 6A to 7B, it can be seen that the radiation pattern of the patch antenna 110 is more concentrated toward the sky in the case where the length of the second elongate portion 131b is longer than the horizontal length of the most adjacent side 112, compared to the case where the length of the second elongate portion 131b is shorter than the horizontal length of the most adjacent side 112. Accordingly, the length of the second extension part 131b of the side wall 131 according to the present disclosure may be greater than or equal to the horizontal length of the most adjacent side 112 of the patch antenna 110. In the vehicle antenna device 100 according to the present disclosure, by setting the length of the second extension part 131b of the side wall 131 surrounding the patch antenna 110 to be greater than or equal to the horizontal length of the most adjacent side 112 of the patch antenna 110, the radiation pattern of the patch antenna 110 can be concentrated toward the sky, thereby effectively improving the reception sensitivity of satellite signals.

According to one embodiment, the vehicle antenna device can direct the main beam toward the sky while maintaining the circular polarization of the patch antenna by using the side walls arranged to surround the patch antenna.

According to one embodiment, the vehicle antenna device can easily tune the antenna according to the conditions of the ground plane by adjusting the length of the first extension part and the second extension part of the side wall.

Although exemplary embodiments of the present disclosure have been described for illustrative purposes, those skilled in the art will appreciate that various modifications, additions, and substitutions are possible, without departing from the idea and scope of the claimed invention. Therefore, exemplary embodiments of the present disclosure have been described for the sake of brevity and clarity. The scope of the technical idea of the present embodiments is not limited by the illustrations. Accordingly, one of ordinary skill would understand the scope of the claimed invention is not to be limited by the above explicitly described embodiments but by the claims and equivalents thereof.

What is claimed is:

1. An antenna device for a vehicle, the antenna device comprising:
a patch antenna configured to implement circular polarization;
a ground plane in contact with a lower surface of the patch antenna; and
a reflector spaced apart from the patch antenna and arranged to surround at least one side surface of the patch antenna.

2. The antenna device of claim 1, wherein the reflector includes at least one side wall configured to surround the at least one side surface of the patch antenna.

3. The antenna device of claim 1, wherein the reflector includes a plurality of side walls.

4. The antenna device of claim 3, wherein the reflector includes n number of side walls, n being a natural number of 3 or more.

5. The antenna device of claim 3, wherein a height of each of the plurality of side walls is the same as a height of the patch antenna.

6. The antenna device of claim 3, wherein each of the plurality of side walls is formed in a ‘T’ shape.

7. The antenna device of claim 3, wherein each of the plurality of side walls includes:
a first extension part extending from the ground plane along a height direction of the patch antenna; and
a second extension part extending along a direction perpendicular to the height direction.

8. The antenna device of claim 7, wherein the second extension part is arranged parallel to an adjacent side surface of the patch antenna.

9. The antenna device of claim 7, wherein the second extension part is arranged parallel to a most adjacent side surface among the side surfaces of the patch antenna.

10. The antenna device of claim 9, wherein a length of the second extension part is greater than or equal to a horizontal length of the adjacent side surface of the patch antenna.

11. The antenna device of claim 7, wherein each of the plurality of side walls is disposed such that one end of the first extension part contacts the ground plane.

12. The antenna device of claim 11, wherein a center in an extension direction of the second extension part contacts the other end of the first extension part.

13. The antenna device of claim 1, wherein when viewed in a direction from an upper surface of the patch antenna toward a lower surface, the patch antenna is formed in an n-polygon, n being a natural number of 3 or more.

14. A vehicle comprising the antenna device of claim 1.

15. An antenna device for a vehicle, the antenna device comprising:
a patch antenna configured to implement circular polarization;
a ground plane in contact with a lower surface of the patch antenna; and
a reflector having a plurality of side walls each spaced apart from the patch antenna and arranged to surround side surfaces of the patch antenna.
